(19) United States
(12) Patent Application Publication
(10) Pub. No.: US 2014/0263533 A1
(43) Pub. Date: Sep. 18, 2014

(54) DRIVE ROLL ASSEMBLY

(71) Applicant: Lincoln Global, Inc., City of Industry, CA (US)

(72) Inventors: Edward A. Enyedy, Eastlake, OH (US); Steven R. Peters, Huntsburg, OH (US)

(73) Assignee: Lincoln Global, Inc., City of Industry, CA (US)

(21) Appl. No.: 13/827,091

(22) Filed: Mar. 14, 2013

(51) Int. Cl. B23K 9/133

(52) U.S. Cl. CPC B23K 9/1336
USPC 226/181; 226/188

(57) ABSTRACT

A wire feeder includes a wire feeder housing that encloses one or more drive roll assemblies rotatably connected with respect to the wire feeder housing for engaging welding wire. Each of drive roll assemblies includes a biasing element that adjusts compressive forces applied to the welding wire.

### TECHNICAL FIELD

The invention pertains to a welding wire feeder, and more particularly, to a welding wire feeder having drive rolls that include a biasing member that facilitates the movement of a welding wire to a workpiece.

### BACKGROUND OF THE INVENTION

Wire feeders, like those used in arc welding applications, convey wire from a continuous feed source to a weld torch. Typically, wire feeders include motor-driven drive rolls that engage diametrically opposite sides of a wire to move the wire along a path through a housing of the feeding mechanism. Once through the housing, the wire is moved through a flexible tube or conduit leading to a welding gun. Often, the conduit also carries shielding gas and electrical current to the welding gun.

Typically, each of the drive roll is mounted on a roller support and all of the roll supports are driveably engaged with one another. Thus, powered rotation of a single roller support causes rotation of all the roll supports and the drive rolls supported thereon. Typically, the drive rolls are a single pair of opposed rolls or a double pair of opposed rolls spaced apart along the wire path. In either arrangement, the drive rolls have an upstream side at which the wire enters the drive rolls and a downstream side at which the wire exits the driver rolls. On the upstream side, the wire is guided through an upstream tube toward a bite created between the drive rolls adjacent the upstream side. Likewise, on the downstream side, the wire exits the drive rolls and is guided through a downstream tube adjacent the downstream side. If a double pair of opposed rolls are used, another tube can be provided between the pairs of drive rolls to further guide the wire.

To impart an advancing force or motion to the wire, opposing drive rolls are positioned sufficiently close to one another so that the wire extending along the pathway is compressed between the opposing rolls. The compressive force in combination with friction between the material of the wire and the rolls advances the continuous length of wire along the wire path in a generally smooth and continuous manner.

The wire passing through the drive rolls has a generally round cross-section and is engaged tangentially by opposing, flat-faced drive rolls mounted transversely to the wire. As a result of this arrangement, the compressive forces exerted on the wire by the driver rolls can often cause the wire to undesirably deform. The material characteristics of the wire largely determine the magnitude or amount the wire is deformed as a result of the compressive forces. Accordingly, a wire made from a material having a relatively high compressive yield strength, such as steel, will be deformed less than a wire made from a material having a moderate compressive yield strength, such as aluminum.

Reductions in the required compressive force are generally considered desirable and can decrease wear on the wire feeder and can also reduce slippage of the wire relative to the drive rolls. Accordingly, any improvements to the drive rolls that decreases the required compressive force needed to drive the wire engaged by the drive rolls is deemed desirable.

### BRIEF SUMMARY

The present invention provides new and improved drive rolls for use in wire feeders that overcome the foregoing difficulties and others and provide the aforementioned and other advantageous features. More particularly, in accordance with one aspect of the present invention, a wire feeder for conveying associated welding wire comprises a wire feeder housing, a welding gun operatively connected to the wire feeder for conveying associated welding wire used in arc welding, and a drive roll assembly disposed within the housing and configured to advance a wire electrode along a wire path into the welding gun, the drive roll assembly including a plurality of shafts each driven by a motor, a drive hub assembly rotatably connected to a respective shaft and configured to rotate about an axis therewith, at least one pair of drive rolls rotatably positioned upon a respective drive hub assembly, wherein each drive roll has an exterior surface and an interior surface, and the interior surface includes a circumferential groove located therein, and at least one biasing member positioned within the groove of each of the at least one pair of drive rolls.

In accordance with another aspect of the invention, a drive roll assembly for use with a welding wire feeder is provided. The drive roll assembly comprises a drive hub assembly configured to rotate about an axis therewith, at least one pair of drive rolls rotatably positioned upon a respective drive hub assembly, wherein each drive roll has an exterior surface and an interior surface, and the interior surface includes a circumferential groove located therein, and at least one biasing member positioned within the groove of each of the at least one pair of drive rolls.

### BRIEF DESCRIPTION OF THE DRAWINGS

FIG. 1 is a perspective view of a wire feeder used in a welding application according to an embodiment of the invention;

FIG. 2 is a side view of a wire feeder and wire feed source according to an embodiment of the invention;

FIG. 3 is a close up side view of drive rolls feeding wire according to an embodiment of the invention;

FIG. 4 is an expanded perspective view of a feed plate and accompanying drive rolls, according to the embodiments of the subject invention;

FIG. 5 is side view of a drive roll assembly which includes a biasing member according to an embodiment of the invention;

FIG. 6 is a cross sectional view of the drive roll assembly of FIG. 5;

FIG. 7 is a side view of a pair of drive roll assemblies, each including a biasing member, and engaging a welding wire according to an embodiment of the invention; and

FIG. 8 is a cross sectional view of the pair of drive roll assemblies engaging a welding wire of FIG. 7.

### DETAILED DESCRIPTION OF THE INVENTION

Referring now to the drawings wherein the showings are for purposes of illustrating embodiments of the invention only and not for purposes of limiting the same, FIG. 1 shows a wire feeder depicted generally at 10. Wire feeder 10 comprises a device for conveying wire 13 from feed source 15, i.e. wire supply 15, for use in a particular application. For illustrative purposes, wire feeder 10 will be described in the context of arc welding. However, other applications will become apparent to those skilled in the art, all of which should be construed as falling within the scope of coverage of the embodiments of the subject invention. In one embodiment, wire 13 may comprise a welding electrode 13a, also referred to herein as welding wire 13a, and wire feeder 10 may comprise welding wire feeder 11. Wire 13, 13a may be drawn continuously from reel 22, box or drum, and delivered to work piece 19, which in the current embodiment is a weldment. Accordingly, wire feeder 10, or welding wire feeder 11, may include a drive assembly that utilizes power from one or more locomotive devices that drive wire 13, 13a to the application work site or work piece 19.

With continued reference to FIG. 1, welding wire feeder 11 may be used in conjunction with welding power source 12 as manufactured by, for example, the Lincoln Electric company in Cleveland, Ohio. Welding power source 12 may receive electrical input power, from an outside source, that is directed to an onboard transformer, not depicted in the figures. Output from the transformer may subsequently be connected to welding output terminals 14, or studs 14 of welding power source 12. Additionally, welding power source 12 may include a regulated power supply for delivering electrical power to one or more welding accessories, which may include welding wire feeder 11. A welding gun, designated generally at 26, and wire conduit may be electrically connected to welding power source 12 through welding wire feeder 11 for delivering welding current in a manner known in the art. It follows that welding wire 13a is fed through weld gun 26 and metered out, i.e. dispensed, at the discretion of the application and/or end user in any manner suitable for conducting the welding process. It is noted that the electrode, i.e. welding wire 13, conducts electricity for establishing a welding arc, wherein the electrode is conveyed to work piece 19 having a voltage potential equal to or approximately equal to the output voltage of welding power source 12, which may be substantially greater than ground.

Different modes of conveying welding wire 13a are known in the art, an example of which includes pushing the welding wire 13a to the weld gun 26 via power or torque provided by the locomotive device. Other modes of conveying welding wire 13a include push/pull modes that utilize multiple locomotive devices. In any instance, welding wire 13a is delivered to weld gun 26, which may have a trigger or other activation mechanism for dispensing wire 13 at the users discretion. At times, it may be necessary to deliver welding wire 13a at varying rates of feed. Therefore, the locomotive device, which may comprise or include drive motor 18, has an output that is adjustable for varying the rate which welding wire 13a is discharged from wire feeder 10. In particular, drive motor 18 itself may be a variable speed drive motor 18.

It is noted here that wire feeder 11 and/or drive motor(s) 18 may draw operating power from the regulated power supply onboard welding power source 12. Alternatively, welding wire feeder 11 may draw power from the open circuit voltage of welding power source 12, or an altogether separate power source. Still any manner of providing power to operate welding wire feeder 11 and/or drive motors 18 may be chosen with sound engineering judgment as is appropriate for use with the embodiments of the present invention.

With continued reference to FIG. 1 and now also to FIGS. 2 and 3, welding wire feeder 11 may include a drive assembly, or drive roll assembly. As mentioned above, drive motor 18, also called a wire feeder motor 18, delivers power, i.e. torque, to convey welding wire 13a to weld gun 26 and subsequently to work piece 19. Drive rolls 36 are included that grip welding wire 13a for pushing or pulling welding wire 13a in the appropriate direction, i.e. toward the work piece. Drive rolls 36 are rotatably connected with respect to a frame member or other portion of wire feeder 11. In one particular embodiment, drive rolls 36 are rotatably connected to feed plate 39 or possibly the wire feeder housing.

With reference to FIG. 3, drive roll assembly may include a plurality of electrically conductive wire support guides 21 spaced along a wire trajectory. Wire support guides 21 may each incorporate a wire passage, or through-hole, for guiding wire 13, 13a. Wire support guides 21 may be oriented such that the wire passages are axially aligned and thereby define the wire trajectory in the region between drive rolls 36, which may comprise adjacently positioned pairs of drive rolls 36. The plurality of wire support guides 21 may include first and second end guides 21a, 21b. Additionally, center guide 21c may be disposed between pairs of drive rolls 36. Still, it will be appreciated that any configuration and quantity of wire support guides 21 and drive rolls 36 may be included as chosen with sound judgment.

Each drive roller 36, in accordance with one embodiment of the subject invention, may include an outer circumference 37 for contacting welding wire 13a and a hub 54 for rotation about a central axis. In an exemplary manner, drive rolls 36 may be cylindrical in configuration, or more specifically disk-shaped, although the particular configuration should not be construed as limiting. The surface, i.e. outer circumference 37, of driver roll 36 may be comprised of a sufficiently hardened material, like steel, that is durable and suitable for gripping wire 13, 13a. In one embodiment, drive rolls 36 may be disposed in pairs along the wire trajectory with each drive roller pair being supported on opposing sides thereof such that respective outer circumferences 37 contact opposite sides of wire 13, 13a. It is noted that the central axes of respective drive rolls 36 extend substantially parallel with one another and generally transverse to the trajectory of wire 13, 13a. In one particular embodiment, the relative position of drive rolls 36 in one set, or pair, may be adjustable for use with wires of different diameters. Stated differently, the outer circumference of one drive roll 36 may be adjustable with respect to the outer circumference of an adjacent driver roll 36 for changing the distance therebetween thus accommodating different sizes of wire 13, 13a. In this manner, the driver roller pairs may be selectively positioned for gripping welding wire 13, 13a with the appropriate amount of gripping force.

Hubs 54 of the drive rolls 36 may be rotatably supported by feed plate 39 or other portion of the housing 39a, as previously mentioned. In one embodiment, hubs 54 are supported by bearing(s) 50 incorporating a plurality of rolling elements, or alternatively by bushings. However, any means for facilitating sustained rotational operation of drive rolls 36 may be chosen as is appropriate for use with the embodiments of the subject invention. Shafts 55 may be included that extend from hub 54 and into engagement with a bearing race. In one exemplary manner, drive rolls 36 may be mounted on corresponding shafts 55 for rotation therewith by a key and keyway arrangement, although any suitable arrangement for engaging the drive rolls 36 may be incorporated. Additionally, shafts 55 for each set or pair of drive rolls 36 may be drive-ably engaged with drive motor 18 and with one another such that shafts 55 rotate together for conveying wire 13, 13a in a desired direction. Shafts 55 may be drive-ably engaged via gears or pulleys and belts, not shown, retained on shafts 55 by any suitable mechanism, like for example a set screw or other fastener. It will be understood that the gears or pulleys may have sufficient clearance between the extents thereof to accommodate relative radial movement of outer circumferences 37 of drive rolls 36 in a manner consistent with that described above. It is noted here that shafts 55 and corresponding driver rolls 36 rotate in opposing directions for advancing wire 13, 13a in a designated direction. In other words, driver roll 36 on one side of wire 13, 13a may rotate clockwise while drive roll 36 on the opposing side of wire 13, 13a rotates counterclockwise, as illustrated by the arrows in FIG. 3.

Still referencing FIG. 2 and now also FIG. 4, feed plate 39 may comprise a generally rigid piece of material suitably strong for supporting the drive roll assembly. In one embodiment, feed plate 39 may be separate from the housing of wire feeder 11 and affixed to the housing via fasteners or other means. Accordingly, feed plate 39 is mounted onto or within the wire feeder housing. Feed plate 39 may be comprised of aluminum. However, feed plate 39 may be comprised of other materials including steel in any of various alloys or other non-metallic materials having sufficient strength and rigidity for supporting the drive assembly. It should be noted that during operation of wire feeder 11, feed plate 39 may be subject elevated temperature. Accordingly, feed plate 39 will have the requisite rigidity and the ability to withstand high temperatures without failure. In one particular embodiment, feed plate 39 may be constructed from an electrically non-conducting material for preventing arcing or sparking resulting from differences in voltage potential between components of the drive roll assembly, examples of which may include ceramic based materials. Alternatively, feed plate 39 may be constructed from polymeric material. Still, any suitable material may be used to construct feed plate 39 as chosen with sound engineering judgment. Feed plate 39 may have a thickness in the range of ¼ inch to 1½ inches thick. However, any thickness of material, or length and width of material, may be chosen with sound engineering judgment. It is noteworthy to mention that alternate embodiments of the subject invention are contemplated wherein the drive roll assembly is connected directly to the housing of wire feeder 11, and not to feed plate 39. In this instance, housing 39a itself may be sufficiently rigid and strong to support the drive roll assembly functioning effectively as feed plate 39. Still it is to be construed that any manner of supporting the drive roll assembly may be chosen without departing from the intended scope of coverage of the embodiments of the subject invention.

FIG. 4 shows an embodiment of one configuration of feed plate 39 and drive rolls 36. In this configuration, bearings 50 may be installed into feed plate 39, which may have recesses that receive the outer bearing race. In particular, four (4) bearings are shown, although the number of bearings 50 may vary without departing from the intended scope of coverage of the embodiments of the subject invention. Shafts 55, or alternatively pins, may connect drive rolls 36 with bearings 50. It follows that shafts 55 may be received into the bearings 50 and may be press fit into a fixed relationship with respect to the bearing inner race. In this manner, driver roll 36, shaft 55 and inner bearing race rotate together.

In a further embodiment, as shown in FIGS. 5 and 6, each drive roll 36 also includes at least one biasing member. Each drive roll 36 has an exterior surface and an interior surface, and the interior surface includes a circumferential groove located therein and biasing member 36 is positioned within the groove of each of drive rolls 36.

Biasing member 60 includes, but is not limited to, a thermoplastic o-ring, a thermoset o-ring, and a toroidal spring. When biasing member 60 is a thermoplastic o-ring, the composition includes a thermoplastic elastomer, a thermoplastic polyolefin, a thermoplastic polyurethane, a thermoplastic polyamide, a melt processible rubber, a thermoplastic vulcanizate, and mixtures thereof. When biasing member 60 is a thermoset o-ring, the composition includes a butadiene rubber, butyl rubber, chlorosulfonated polyethylene, ethylene propylene rubber, ethylene propylene diene monomer, fluoroelastomer, nitrile rubber, perfluoroelastomer, polyacrylates rubber, polychloroprene, polyisoprene, polysufide rubber, silicone rubber, and styrene butadiene rubber.

If biasing member 60 is an insulator, then drive rolls 36 may be insulated from bearing 50. This will eliminate the need for the use of separate insulators in order to prevent an electrical current from passing through bearing 50. In general, biasing member 60 is positioned between drive roll 36 and bearing 50. In the free state, i.e. when the drive roll assembly is not assembled to the wire drive, drive roll 36 is concentric with bearing 50.

When housed in wire feeder 10, the drive roll assemblies are mounted to a wire drive. The mounted drive roll assemblies are shown in FIGS. 7 and 8. The wire drive has a mechanism to position the drive roll assemblies to a position that causes biasing member 60 to compress. The mechanism of the wire drive is an idle arm (not shown) that is moved either rotationally or translationally in order to provide the compressive forces to biasing member 60. In one embodiment, biasing element 60 is not fully compressed, and a gap in the range from about 0.001 to about 0.010 inches exists between bearing 50 and driver roll 36. This gap allows for drive roll 36 to “float” relative to the axis of bearing 50 as welding wire 13 size changes, and to compensate for machining tolerances of drive roll 36 itself. The selection of the appropriate biasing member 60 is determined by the wire type, size, and composition. This selection results in the compressive force being set in conjunction with drive rolls 36.

Power supplied to drive rolls 36 causing them to spin can be applied directly to drive rolls 36 or through the drive hub assembly. In one embodiment, a gear interfaces with drive roller 36 and is on the same centerline as bearing 50. Pins on the gear go into holes located in drive rolls 36. The size of the holes are large enough to compensate for the movement of bearing 50 within the drive roll assembly as biasing element 60 compresses. It is envisioned that other shapes, other than holes, may be used for transmitting torque to drive rolls 36 including, but not limited to, slots, grooves, and couplings such as Oldham couplings. In another embodiment, the gear may drive the drive hub assembly. In this manner, torque is transferred through biasing element 60 into drive roller 36. This configuration allows biasing element 60 to also function as a clutch. In this manner, when the torque becomes too high, biasing element 60 will allow for slip between drive roller 36 and the drive hub assembly. This is useful in the prevention of birdnesting.

The invention has been described with reference to the preferred embodiments. Obviously, modifications and alterations will occur to others upon reading and understanding the preceding description. It is intended that the invention be construed as including all such modifications and alterations insofar as they are within the scope of the appended claims or the equivalents thereof.

What is claimed is:

1. A wire feeder for conveying associated welding wire, the wire feeder comprising:
a wire feeder housing;
a welding gun operatively connected to the wire feeder for conveying associated welding wire used in arc welding; and
a drive roll assembly disposed within the housing and configured to advance a wire electrode along a wire path into the welding gun, the drive roll assembly including:
at least one drive hub assembly driven by a motor;
said at least one drive hub assembly rotatably connected to a respective shaft and configured to rotate about an axis therewith;
at least one drive roll rotatably positioned upon a respective drive hub assembly, wherein each drive roll has an exterior surface and an interior surface, and the interior surface includes a circumferential groove located therein; and
at least one biasing member positioned within the groove of each of the at least one drive roll.

2. The wire feeder of claim 1, wherein the at least one biasing member is selected from the group consisting of a thermoplastic o-ring, a thermoset o-ring, and a toroidal spring.

3. The wire feeder of claim 2, wherein the thermoplastic o-ring is composed of a material selected from the group consisting of a thermoplastic elastomer, a thermoplastic polyolefin, a thermoplastic polyurethane, a thermoplastic polyamide, a melt processible rubber, a thermoplastic vulcanizate, and mixtures thereof.

4. The wire feeder of claim 2, wherein the thermoset o-ring is composed of a material selected from the group consisting of a butadiene rubber, butyl rubber, chlorosulfonated polyethylene, ethylene propylene rubber, ethylene propylene diene monomer, fluoroelastomer, nitrile rubber, perfluoroelastomer, polyacrylates rubber, polychloroprene, polyisoprene, polysufide rubber, silicone rubber, and styrene butadiene rubber.

5. The wire feeder of claim 1, wherein the biasing member is compressible.

6. The wire feeder of claim 1, wherein the biasing element creates a gap between the interior surface of each drive roll and the hub assembly.

7. The wire feeder of claim 7, wherein the gap between the interior surface of each drive roll and the hub assembly is in the range from about 0.001 inches to about 0.010 inches.

8. The wire feeder of claim 1, wherein the biasing member is an insulator.

9. A drive roll assembly for use with a welding wire feeder, the drive roll assembly comprising:
a drive hub assembly configured to rotate about an axis therewith;
at least one pair of drive rolls rotatably positioned upon a respective drive hub assembly, wherein each drive roll has an exterior surface and an interior surface, and the interior surface includes a circumferential groove located therein; and
at least one biasing member positioned within the groove of each of the at least one pair of drive rolls.

10. The drive roll assembly of claim 9, wherein the at least one biasing member is selected from the group consisting of a thermoplastic o-ring, a thermoset o-ring, and a toroidal spring.

11. The drive roll assembly of claim 10, wherein the thermoplastic o-ring is composed of a material selected from the group consisting of a thermoplastic elastomer, a thermoplastic polyolefin, a thermoplastic polyurethane, a thermoplastic polyamide, a melt processible rubber, a thermoplastic vulcanizate, and mixtures thereof.

12. The drive roll assembly of claim 10, wherein the thermoset o-ring is composed of a material selected from the group consisting of a butadiene rubber, butyl rubber, chlorosulfonated polyethylene, ethylene propylene rubber, ethylene propylene diene monomer, fluoroelastomer, nitrile rubber, perfluoroelastomer, polyacrylates rubber, polychloroprene, polyisoprene, polysufide rubber, silicone rubber, and styrene butadiene rubber.

13. The drive roll assembly of claim 9, wherein the biasing member is compressible.

14. The drive roll assembly of claim 9, wherein the biasing element creates a gap between the interior surface of each drive roll and the hub assembly.

15. The drive roll assembly of claim 15, wherein the gap between the interior surface of each drive roll and the hub assembly is in the range from about 0.001 inches to about 0.010 inches.

16. The drive roll assembly of claim 9, wherein the biasing member is an insulator.
